(19) United States
(12) Patent Application Publication
(10) Pub. No.: US 2002/0174336 A1
(43) Pub. Date: Nov. 21, 2002

(54) Information protection system and information protection method

(75) Inventors: Tatsuhiko Sakakibara, Tokyo (JP); Ichiro Kasuga, Tokyo (JP)

Correspondence Address: Scott A. Chapple, Dobrusin & Thennisch PC, Suite 311, 401 South Old Woodward Avenue, Birmingham, MI, 48009, US

(73) Assignee: Mobilty Co., Ltd.

(21) Appl. No.: 10/124,524

(22) Filed: Apr. 17, 2002

(30) Foreign Application Priority Data
Apr. 17, 2001 (JP) 2001-118795

(51) Int. Cl. H04L 9/32; H04L 9/00

(52) U.S. Cl. 713/172; 713/200; 380/247

(57) ABSTRACT

To provide a manipulation device for a gaming machine that creates realistic sensations by means of providing responding means operated in response to feedback from a gaming machine body, the responding means being provided on the side of the manipulation device for a gaming machine having a plurality of control buttons to be used for a video gaming machine.

In the manipulation device for a gaming machine that supplies manipulation data to the gaming machine body that are obtained as a result of the manipulation of the control buttons to get a game going by using bi-directional communication means that appropriately receives data from the gaming machine body, the manipulation device for a gaming machine comprises responding means that is activated in response to a specific responding signal supplied from the gaming machine body. Different control data can be supplied to a single or a plurality of responding means by providing, as dynamic transmission data to be supplied from the gaming machine body to the manipulation device for a gaming machine, an identification code region to specify the responding means and a plurality of control data regions for the responding means specified with the identification code.

### CROSS-REFERENCE TO RELATED APPLICATIONS

The present application claims priority from Japanese Patent Application No. 2001-118795 filed Apr. 17, 2001, the disclosure of which is hereby incorporated by reference herein.

### FIELD OF THE INVENTION

The present invention relates to the protection of information by using wireless communication.

### BACKGROUND OF THE INVENTION

A huge number of magnetic stripe cards have been around in the market. Examples of such magnetic stripe cards include credit cards, cash cards, prepaid cards, employee ID cards, student ID cards, pass cards, cards used for credentialing purposes, library cards, and time cards. These cards are available for specific applications and purposes. People might be required to carry several cards when they go out. However, even a few or more cards may take up much space and, in addition, it may take some doing to pick up the right card when necessary.

A partial solution to these problems is to integrate several cards into a single card whenever possible. For example, a combination of cash cards of banking facilities and credit cards has been in practical use as a debit card. An owner of the debit card can use it to purchase goods and services without carrying cash by simply inserting a debit card into a point-of-sale terminal and entering a personal identification number into the terminal.

However, the owner is required to type the personal identification number into the terminal using a numeric keypad for all transactions. Enduring fear of leakage of the personal identification number is an obstacle to the wide acceptance of such cards. Besides, debit cards are susceptible to falsification if stolen or lost because the debit cards use a magnetic stripe to store information. In fact, a form of falsification called skimming is alarmingly increasing that is victimizing consumers whereby criminals copy the data on the magnetic stripe and use it to produce a counterfeit credit card.

Against the backdrop of the current state of falsification and fraud of the magnetic stripe cards, many industries have embraced the shift from magnetic stripe cards to IC cards. As is well known in the art, IC cards are plastic cards with embedded IC chips. IC cards have the advantage of being harder to tamper with than magnetic stripe cards. They also have the advantage of being relatively easily used for the production of a multi-purpose card incorporating features of two or more cards, because IC cards can hold much more data than magnetic stripe cards.

However, fraud or abuse of an IC card by a third party other than the owner results in significant loss or damage especially in the cards having both sensitive personal information and monetary values on their surface, as in conventional credit cards. On the other hand, some cards (e.g., prepaid cards) with monetary values but without the name of the person they belong to have few possibility that the card is returned to the owner if it is lost or stolen. Further, problems are concerned from the point of view of protecting owner privacy even without any monetary value of the cards (e.g., residence cards and health cards) carrying many sensitive personal information.

With this respect, various attempts have been made to integrate a multi-purpose IC card into a mobile device such as a mobile phone, a personal handy-phone system (PHS), a personal digital assistant (PDA), and a notebook computer, to combine features of different IC cards into such a device, or to provide a mechanism that allows a card or cards to be integrated into a terminal device (e.g., to provide downloadable software programs on a given server that achieve features of an IC card when downloaded, or to use an appropriate proprietary chip for cards carrying such software programs), in which the terminal device is protected from unauthorized use. There are generally two types of IC cards: contact and contactless. Contact cards require insertion into a dedicated terminal (hereinafter, referred to as a “reader/writer”) to use the data recorded on the card. Contactless cards require no insertion. Instead, they require only proximity to a reader/writer. This suggests a system in which a mobile device is protected with a password so that features of the IC card(s) become available only when the password previously stored in the mobile device coincides or matches with the password that a user types in. However, this system involves a burden of typing the password in the mobile device whenever the features of the card(s) are used, which reduces the benefit of the contactless IC cards that requires users to just wave their card over a reader/writer. In addition, passwords are useless in tracking down the actual owner of the device. If the password leaks out for some reasons, a malicious user can access the mobile device using the illegally obtained password.

Alternatively, mobile devices can be remotely controlled via ordinary telephone when it is lost and is in urgent need of the remote control. In other words, this is to prevent the illegal use of the mobile devices by using telephone keypad tones. However, the above method can be used only when an appropriate base station that supports remote operation is available, which makes the method insufficient to surely prevent the illegal use.

The present invention was made in conjunction with the above-mentioned problems, and an object thereof is to provide an information protection system with which sensitive personal information and information associated with monetary values or credits can be consolidated, while surely preventing illegal use of such information by a third party.

Another object of the present invention is to provide an information protection method for achieving the information protection system.

### SUMMARY OF THE INVENTION

An information protection system according to an aspect of the present invention is an information protection system comprising a first assembly in which protected information is stored and a second assembly in which authentication data are stored, wherein the second assembly comprises communication means that allows the second assembly to send information contactlessly in response to a request from the first assembly, and the first assembly comprises receiving means for receiving access to the protected information, authentication means for performing authentication in response to the reception of the authentication data from the second assembly, and access control means that enables or disables the access received by the receiving means, depending on the result of the authentication obtained by the authentication means.

An information protection system according to another aspect of the present invention is an information protection system comprising a first assembly in which first authentication data and protected information are stored, the first authentication data being to be used for authenticating an owner thereof, a second assembly in which second authentication data are stored, the second authentication data being to be used for authenticating the owner, and an information reader for reading the protected information, wherein the first assembly comprises first communication means that allows the first assembly to exchange information contactlessly with the second assembly and the information reader, the second assembly comprises second communication means that allows the second assembly to exchange information contactlessly with the first assembly, and the information reader comprises third communication means that allows the information reader to exchange information contactlessly with the first assembly, the first assembly further comprising means for receiving the second authentication data from the second assembly in response to a signal from the information reader and performing authentication based on the received second authentication data and the first authentication data, thereby to permit or prohibit reading of the protected information by the information reader, depending on the result of the authentication.

In the information protection system according to one aspect of the present invention, the authentication means may be provided in the second assembly, or in both the first and second assemblies. The first and second assemblies may be independently portable. Alternatively, these assemblies may be incorporated into a portable product or products.

There is no limitations on the type of interface that the communication means uses for communication. For example, the communication means may be configured to carry out wireless communications by electromagnetic induction, wireless communications by electromagnetic coupling, wireless communications by electrostatic coupling, communications using frequencies in the microwave region, or communications that use light as a carrier.

Each of the first and second assemblies may be provided as an IC module including an antenna for contactless communications.

The first assembly may be embedded in a card-like material. Alternatively, it may be embedded in a sheet-like material. The first assembly may also be contained in a mobile or portable device. It may be contained in a data carrier.

The second assembly is preferably implemented as what the owner of the first assembly always carries around. More preferably, the first assembly is implemented as what a third party can hardly steal of. For example, the first assembly may be embedded in an adornment or jewelry such as a finger ring.

In another aspect of the present invention, the access control means enables the access to the protected information until a predetermined time period has elapsed from the reception of the access request, when the result of the authentication obtained by the authentication means indicates permission of the access.

The first and second assemblies may be provided as an integrated circuit assembly.

### BRIEF DESCRIPTION OF THE DRAWINGS

FIG. 1 is a schematic block diagram of an information protection system according to an embodiment of the present invention;

FIG. 2 is a flow chart that is carried out by a CPU 31 of an IC assembly 30 for authentication processing upon an access request to the IC assembly 30;

FIG. 3 is an illustration of a multi-purpose mobile device 300 and an R badge 400;

FIG. 4 is an illustration of an example where a reader/writer 50 for contactless IC cards is provided on an automatic ticket gate;

FIG. 5 is a view illustrating a configuration of a mobile device having an RFID interface;

FIG. 6 is a view illustrating a configuration of a mobile device having a plurality of RFID interfaces;

FIG. 7 is a view illustrating a software configuration in the mobile device;

FIG. 8 is a view illustrating a configuration of an IC card;

FIG. 9 is a view illustrating a mechanism of exchanging data by electromagnetic induction;

FIG. 10 is a flow chart illustrating operations to receive data;

FIG. 11 is a flow chart illustrating operations to send data;

FIG. 12 is a view illustrating a configuration of an individual information system;

FIG. 13 is a view illustrating how individual information is stored in a mobile device;

FIG. 14 is a flow chart illustrating operations of an individual information system;

FIG. 15 is a view illustrating a configuration of a user identification system;

FIG. 16 is a view of an example of a red badge;

FIG. 17 is a view of an example of a red badge;

FIG. 18 is a view of an example of a red badge;

FIG. 19 is a view illustrating a configuration of an IC chip used in a red badge;

FIG. 20 is a flow chart illustrating operations to register identification information;

FIG. 21 is a flow chart illustrating operations to determine availability based on the identification information;

FIG. 22 is a view of an example where a red badge is used for an individual information system;

FIG. 23 is a view illustrating a configuration of a carriable recording element write-in system;

FIG. 24 is a flow chart illustrating operations of a carriable recording element write-in system;

FIG. 25 is a view of an example where a red badge is used for a carriable recording element write-in system;

FIG. 26 is a view illustrating a first configuration of a management system;

FIG. 27 is a view illustrating first operations of a log management system;

FIG. 28 shows exemplified display screens of a mobile device;

FIG. 29 is a view of an example where a red badge is used for a first log management system;

FIG. 30 is a view illustrating a second configuration of a log management system;

FIG. 31 is a view illustrating second operations of a log management system;

FIG. 32 shows exemplified display screens of a mobile device;

FIG. 33 is a view of an example where a red badge is used for a second log management system; and

FIG. 34 is a view illustrating how data are exchanged between mobile devices.

### DETAILED DESCRIPTION OF THE PREFERRED EMBODIMENTS

<Schematic Configuration>

An embodiment of the present invention is described with reference to the drawings.

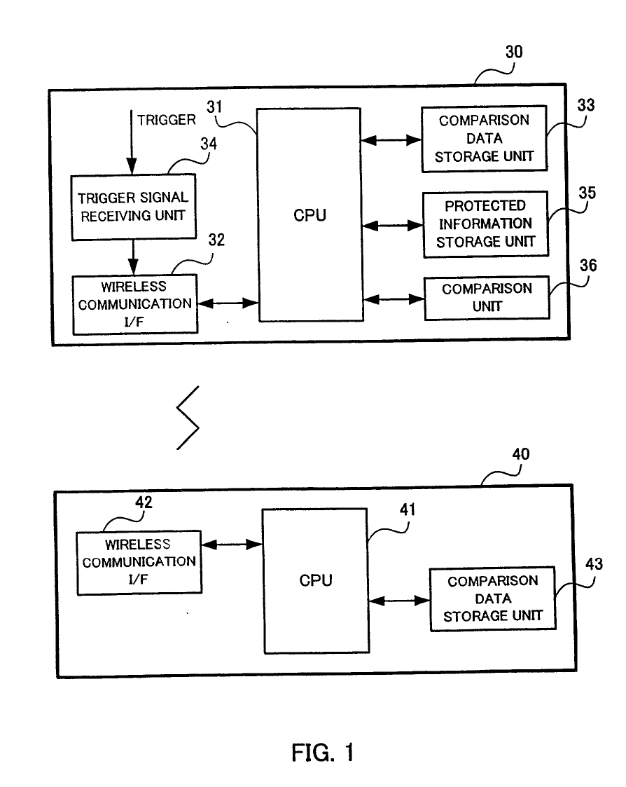

FIG. 1 is a schematic block diagram of an information protection system according to an embodiment of the present invention. The information protection system comprises a first IC assembly 30 and a second IC assembly 40. The first IC assembly comprises a central processing unit (CPU) 31, a wireless communication interface unit 32, a comparison data storage unit 33, a trigger signal receiving unit 34, and a protected information storage unit 35. Likewise, the second IC assembly 40 comprises a CPU 41, a wireless communication interface unit 42, and a comparison data storage unit 43. The first and second IC assemblies 30 and 40 each includes a read-only memory (ROM) or a random-access memory (RAM) which are not shown and which store application and control programs, an operating system (OS), and a device driver necessary for the corresponding assembly.

The first IC assembly 30 and the second IC assembly 40 are configured so that they can exchange data with each other by using wireless communication. In this event, the term “wireless communication” as used herein generally refers to communication in a broad sense that is performed without physical electric contact of metal pads. Examples include wireless communications using electromagnetic coupling, electromagnetic induction, microwaves, or light as those used in conventional radio frequency identification systems (RFIDs). Further, communications based on transbody transmission of power and information, as disclosed in U.S. Pat. No. 6,211,799 (corresponding to Japanese Patent Laid-open No. 11-225119), are also encompassed by the term “wireless communication” herein.

The CPU 31 controls the components of the first IC assembly 30. The CPU 41 controls the components of the second IC assembly 40. The wireless communication interface units 32 and 42 each has functions of both transmitting and receiving data. Each of the wireless communication interface units 32 and 42 comprises an antenna and a coil that are typically used for RFID technology for example, to exchange data with each other.

Although RFID operates over a wide range of frequencies and communication protocols using different modulation technique, the present invention is not limited to a specific one. Any one of possible combinations may be used. There is no limitation on the number of the wireless communication interface units in the IC assembly. Different wireless communication interface units may be provided that operate using different modulation technique depending on the necessity. From a versatility standpoint, it is preferable to comply with the specification currently under standardization in the field of contactless IC cards. In Japan, the Next Generation IC Card System Study Group and Japan IC Card System Application Council are performing standardization. Besides, there are already established international standards, i.e., ISO/IEC 10536, ISO/IEC 14443, and ISO/IEC 15693. The wireless communication interface units 32 and 42 may provide a more versatile and feasible information protection system when they comply with such standards.

The comparison data storage units 33 and 43 store data that are used to compare the first and second IC assemblies. Access to the protected information storage unit 35, e.g., access to data or a program stored in the protected information storage unit 35 is permitted only when the comparison data satisfy a predetermined condition. The comparison data are those used to uniquely identify an owner of the IC assembly and details thereof are not specifically limited. For example, the comparison data may be a unique product code or product number for a CPU, a credit card number, a combination of such unique data or encrypted version of them. The protected information used herein may be any information or data that the owner of the IC assembly wants to protect and limit browsing or use by a third party, such as sensitive personal information and information associated with monetary values. Examples thereof include those recorded on conventional cards and equivalents thereof, such as credit cards, cash cards, prepaid cards, membership cards, clinical records and tickets, health insurance cards, ID cards, and season tickets, as well as electronic money, information associated with electronic business transactions, private directories and other documents, and image data.

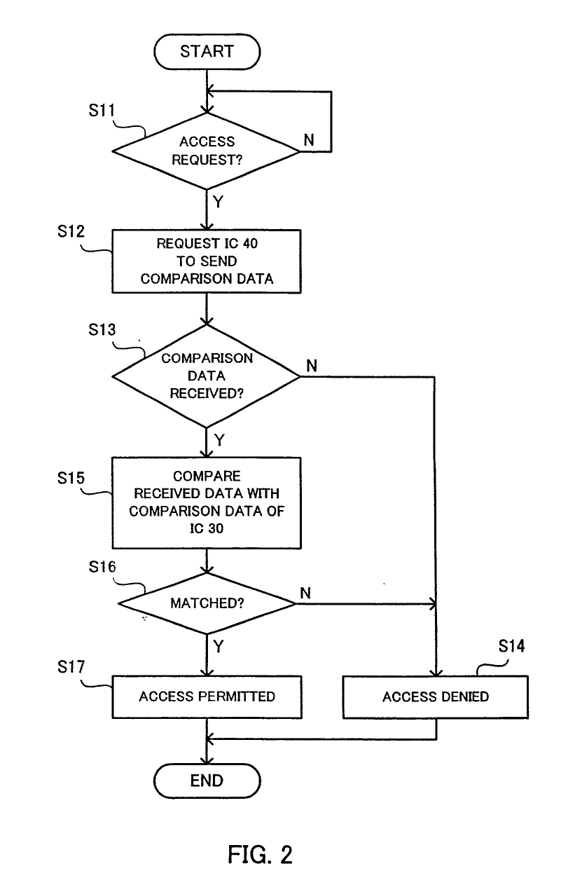

FIG. 2 shows a flow chart that is carried out by a CPU 31 of an IC assembly 30 for authentication processing upon an access request to the IC assembly 30.

The wireless communication interface unit 32 is connected to the trigger signal receiving unit 34 and receives a trigger signal which is described later. The CPU 31 determines that there is no access request to the IC assembly 30 when no trigger signal is received by the trigger signal receiving unit 34. On the other hand, it determines that there is an access request when the trigger signal is received (S11). When a trigger signal is detected, the CPU 30 sends a request signal to the second IC assembly 40 via the wireless communication interface 32, to request the comparison data in response to the trigger signal (S12). The second IC assembly 40 supplies the comparison data stored in the local comparison data storage unit 43 to the first IC assembly in response to the request signal. The CPU 31 determines whether the comparison data is received via the wireless communication interface 32 (S13). When not received, access is denied (S14). When the comparison data is received, the CPU 31 starts comparison between the comparison data received from the second IC assembly 40 and the comparison data stored in the comparison data storage unit 33 of the IC assembly 30 (S15). In this example, the comparison is performed by a comparison unit 36.

It is then determined whether a predetermined condition is satisfied as a result of the comparison performed by the comparison unit 36. In this example, it is determined whether the data received from the IC assembly 40 match IC comparison data (S16). When matched, the CPU 31 permits the access (S17) and extracts necessary information from the protected information storage unit. On the other hand, when the predetermined condition is not satisfied, the CPU 31 prohibits the access to the data stored in the protected information storage unit 35 (S14).

The storage units such as the comparison data storage units 33 and 43 and the protected information storage unit 35 may be implemented by using a recording element such as an IC chip. It should be noted that the comparison of the comparison data is performed in the first IC assembly 30 in the example shown in FIG. 1 but it may be performed in the second IC chip assembly 40. In such a case, the second IC assembly 40 notifies the first IC assembly 30 of the result of the comparison using wireless communication after the comparison. The CPU 31 determines whether the access to the protected information storage unit 35 is permitted, depending on the result of the comparison. Alternatively, comparison units may be provided both in the first IC assembly 30 and the second IC assembly 40 to exchange different comparison data between them. Access to the protected information storage unit 35 may be permitted only when predetermined conditions are satisfied on both sides. The latter double-comparison ensures more positive protection of the data stored in the protected information storage unit 35.

The above-mentioned first and second IC assemblies may be manufactured by using a well-known semiconductor manufacturing technique. However, the present invention is not limited to semiconductor integrated circuits. For example, the first IC assembly and/or the second IC assembly may be produced by using an optoelectronic integrated circuit (OEIC) or a biochip. The IC assembly thus produced may be embedded in various objects as a small chip. For the purpose of the present invention, an IC assembly embedded in an object that the owner can have around, such as an adornment or clothes, is collectively referred to as an “R badge”. A combination of a mobile device with the sensitive personal information and information associated with monetary values incorporated therein is collectively referred to as a “multi-purpose mobile device”.

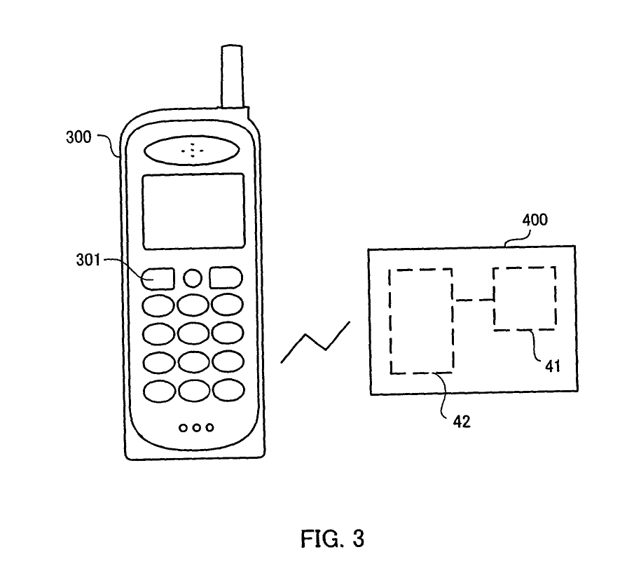

Next, referring to FIG. 3, illustrated is an example where the first IC assembly is achieved as a multi-purpose mobile device 300 and the second IC assembly is achieved as an R badge 400. The multi-purpose mobile device 300 comprises a switch 301. When the owner of the device pushes the switch 301, a trigger signal is generated. The trigger signal receiving unit 34 (FIG. 1) gives an instruction to the wireless communication interface unit 33 to start communication with the second IC assembly, in response to the reception of the trigger signal. Subsequent comparison operations are similar to those described in conjunction with FIG. 1. This makes it possible to compare the comparison data between the multi-purpose mobile device and the R badge and to make the multi-purpose mobile device available only when the result of the comparison satisfies a predetermined condition.

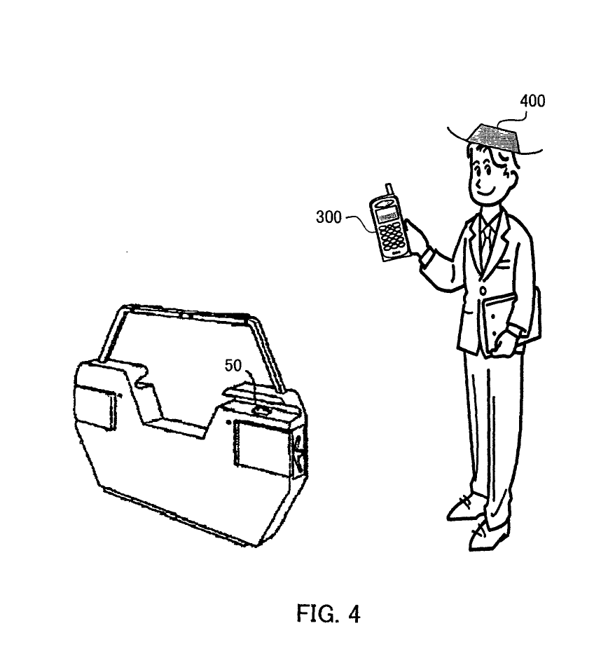

FIG. 4 shows an example where an reader/writer 50 for contactless IC cards is provided on an automatic ticket gate and a signal (precharge signal) supplied from the reader/writer is used as the trigger signal. In this case, the signal supplied from the reader/writer is similar to signals used in well-known RFID systems. When a customer waves the multi-purpose mobile device 300 over the automatic ticket gate, the multi-purpose mobile device 300 begins communication with the R badge 400 in response to the precharge signal supplied from the reader/writer 50. Subsequent comparison operations are similar to those described in conjunction with FIG. 1. This offers benefits to the customer, that is, the customer can pass through the gate only by waving the multi-purpose mobile device over the automatic ticket gate. A similar approach may be applied to other facilities and services than automatic ticket gates. Examples include ATMs inside banking facilities and pay telephones that involve transactions or transfer of credits.

Access to the protected information may be permitted when it is made after the result of the comparison satisfies a predetermined condition but before the lapse of a predetermined time period. The access may be prohibited when the predetermined time period has elapsed. In such a case, a timer may be provided in either one or both of the IC assemblies 30 and 40 to determine whether the above-mentioned predetermined time period has elapsed. This approach makes the present invention feasible even when the distance between the IC assemblies 30 and 40 is longer than an operating distance range.

An example is described where a railway ticket is integrated into the multi-purpose mobile device 300 to pass through an automatic ticket gate. In this example, it is assumed that the operating distance range between the multi-purpose mobile device 300 (IC assembly 30) and the IC assembly 40 is 10 cm. In a typical automatic ticket gate, a customer waves the multi-purpose device 300 over the reader/writer 50 on the automatic ticket gate for authentication while holding it on his or her hand. When the IC assembly 40 is mounted in, for example, a finger ring, the distance between the IC assembly in the multi-purpose device 300 and the finger ring is shorter than 10 cm. Thus, the authentication can be done without any trouble. However, when the IC assembly 40 is mounted in a hat or an earring, the distance between the IC assembly 30 and the IC assembly 40 is often longer than 10 cm. The distance prevents the customer from performing authentication.

In such a case, the customer may move his or her hand with the multi-purpose mobile device 300 close to the hat or the earring to shorten the distance between the IC assembly 30 and the IC assembly 40 to be smaller than 10 cm, and then perform the authentication between the IC assembly 40 and the IC assembly 30. For this purpose, in the example shown in FIG. 3, the customer pushes the switch 301 of the multi-purpose mobile device 300 with the multi-purpose mobile device 300 located in proximity to the hat or the earring to generate a trigger signal for authentication.

In the example shown in FIG. 4, the data of a railway ticket on the mobile device 300 can be made available through authentication by moving the multi-purpose device 300 closer to an ear for authentication so that the distance between the device and the IC assembly 40 mounted in the hat or the earring becomes smaller than 10 cm, with the multi-purpose mobile device 300 located in a region in which it can respond to the precharge signal supplied from the reader/writer 50. As apparent from the above, the timer allows a certain time lag and it is possible to adopt a communication technique that uses a small operating distance range even when the actual distance between the IC assembly 30 and IC assembly 40 is relatively long.

The information on the mobile device may be backed up on a dedicated server or log files indicating specifications may be stored. With such a configuration, an owner can download the information when necessary to, for example, recover the state before the device is stolen.

The owner may have options of using the IC card without any modification and of using it as a mobile device having a feature of the IC card. Further, a well-known GPS function may be provided in the IC assembly 30 so that the data stored in the protected information storage unit 35 can be protected more positively even if the IC assembly 30 is lost.

Next, embodiments are described in detail where the present invention is applied to, for example, a device in conjunction with “First Embodiment” to “Seventh Embodiment”.

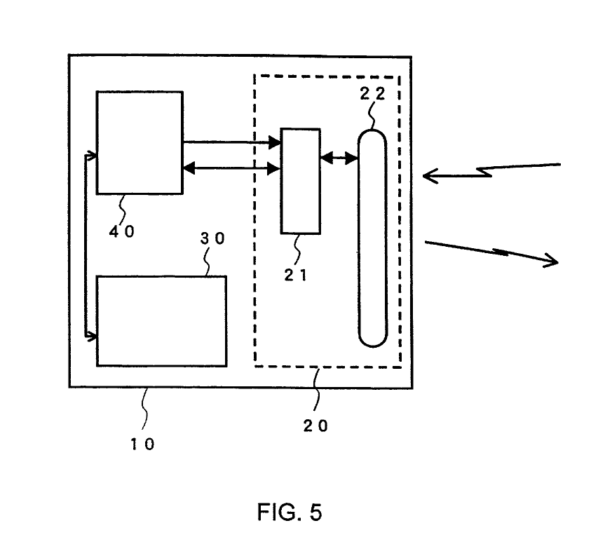

The mobile device 10 in the first embodiment generally comprises a transponder unit 20 for sending out and receiving data using a wave-sensitive procedure, a memory 30 that is made up of a RAM or a ROM, and control unit 40 including a central processing unit (CPU), as shown in FIG. 5.

By the wave-sensitive procedure, the term refers to a transmission procedure typically used in RFID systems to transmit data without electric connections. It uses electromagnetic coupling, electromagnetic induction, microwaves, or light.

The mobile device 10 is a device such as a mobile phone, a personal handy-phone system (PHS), a personal digital assistant (PDA), or a notebook computer. An interface that performs data transmission using the wave-sensitive procedure is hereinafter referred to as an RFID interface.

The control unit 40 is connected to the transponder unit 20 and the memory 30 to control the transponder unit 20 and the memory 30.

The transponder unit 20 integrates a sending unit (or a transmitter unit) and a receiver unit. It has functions of: reading data out of a recording element with an RFID interface through an antenna 22; writing data in the recording element; and sending out data to a reader with an RFID interface.

The recording element may be an IC chip. The following description is made for the case where the recording element is an IC chip.

The transponder unit 20 comprises a communication controlling unit 21 made up of a communication controlling IC or an equivalent thereof and the antenna 22. The following description is made for the case where the communication controlling unit 21 is a communication controlling IC.

The communication controlling IC 21 of the transponder unit 20 is connected to the control unit 40. It sends out and read data through the antenna in response to a command to read data received from the control unit 40.

The memory 30 is connected to the control unit 40. It comprises a region in which data are stored. It also comprises an operating system (OS), a control program such as a device driver used to control the communication controlling IC 21, and application programs.

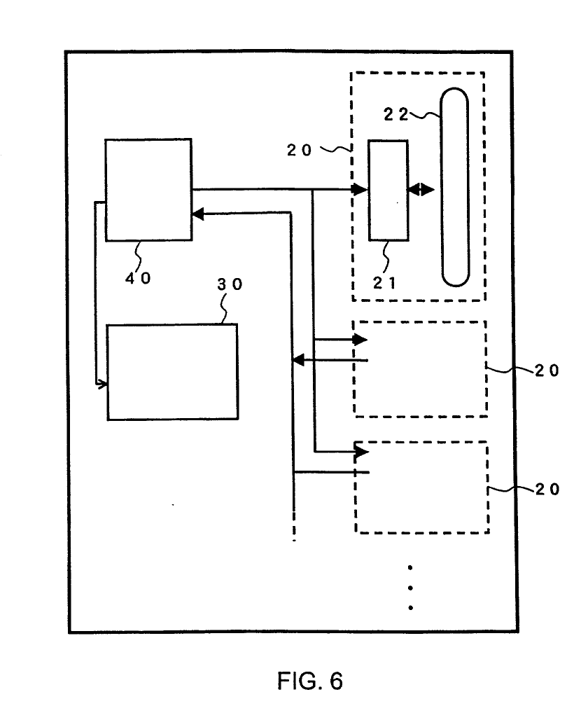

RFID interfaces operate over a wide range of frequencies and communication protocols using different modulation technique. With this respect, corresponding communication controlling ICs 21 and antennas may be provided and two or more control programs such as device drivers used to control the communication controlling ICs 21 may be provided in the mobile device 10 to allow selection of them depending on the necessity, as shown in FIG. 6.

From a standardization standpoint, it is preferable to use RFID interfaces that comply with ISO/IEC 10536 for the close-coupled type, ISO/IEC 14443 for the proximity type, and ISO/IEC 15693 for the vicinity type. It is preferable that the interface supports carrier frequencies of 125 kHz to 400 kHz, 4.9152 MHz, 13.56 MHz, or 2.45 GHz.

Some pairs of RFID interfaces can transmit and receive data through a human body when a user wears one of the pair and holds the other on his or her hand. The interface may be provided with such features to transmit and receive data via something that can propagate or transmit data.

The above-mentioned example is not a limitation. An RFID interface using other procedure or technique may be used when necessary.

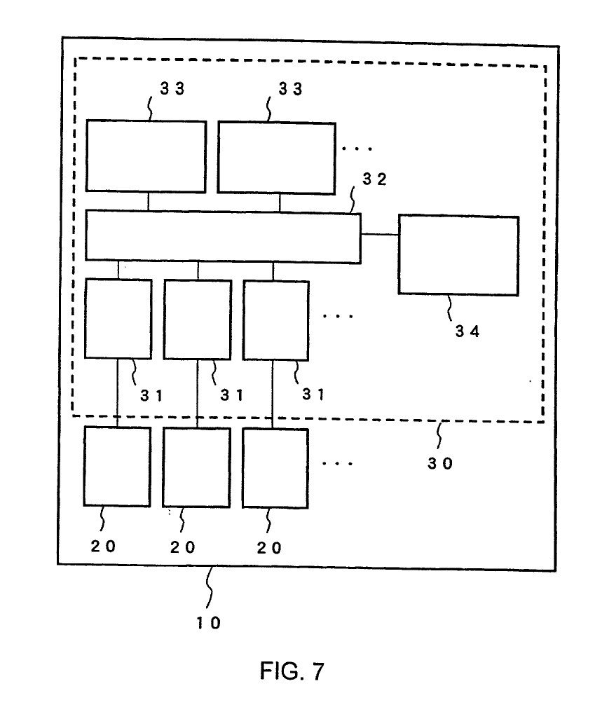

As shown in the block diagram in FIG. 7, the mobile device 10 comprises transponder units 20 for different RFID interfaces and device drivers (control programs) 31 for the RFID interfaces. Many application programs 33 can be run on a system management unit 32 comprising an operating system (OS) and others to achieve various different functions and features. The device may comprise a data storage unit 34 for storing data to be used by an application program 33, when necessary.

The application program 33 and the device driver 31 may be downloaded from a network such as the Internet to add a new function or update it.

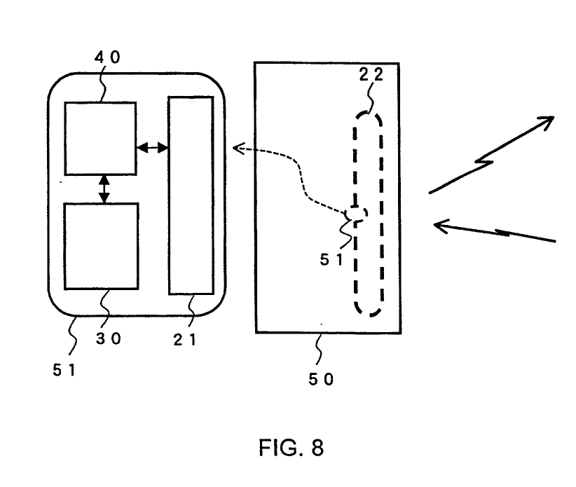

The IC card has functions that are similar to those of the above-mentioned RFID interface. As shown in FIG. 8, an IC chip 51 is connected to the antenna 22 in an IC card 50.

The IC chip 51 that serves as the recording element comprises the communication controlling IC 21, the control unit 40 including a CPU, and the memory 30. The chip transmits and receives data through the antenna 22. The memory 30 is connected to the control unit 40. It comprises a place where data is stored in a memory and software programs that control the communication controlling IC 21. It may comprise an OS.

Alternatively, the components that control communications may be achieved as an integrated circuit.

The above-mentioned transponder unit 20 of the RFID interface may be integrated into any devices or machines which are not shown to provide the function of transmitting and receiving data using the RFID interface.

Next, a mechanism of transmitting and receiving data by the transponder unit 20 is described specifically in conjunction with an example where the data is transmitted and received by using electromagnetic induction.

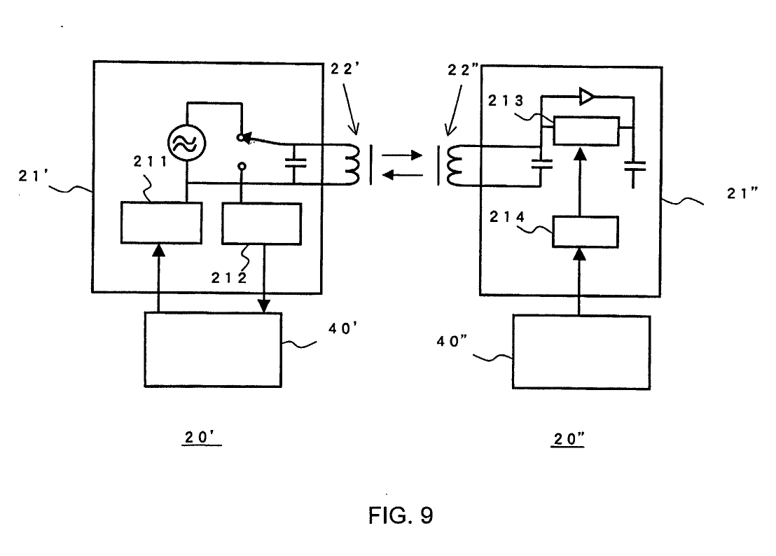

As shown in FIG. 9, the transponder unit 20 is divided into a receiver unit 20′ and a sending unit (transmitter unit) 20″ for the purpose of description.

In the receiver unit 20′, the communication controlling IC 21 comprises a read control unit 211 that begins to read data in response to a reading command from the control unit 40, and a data receiver unit 212 that passes the received data to a control unit 40′.

The read control unit 211 has a function of generating and sending out power pulses as a sending request through an antenna 22′ in response to the reception of the reading command from the control unit 40′. The data receiver unit 212 has a function of decoding the data to pass them to the control unit 40′ in response to the reception of the data supplied from the sending unit 20″ through the antenna 22′.

The sending unit 20″ comprises a condenser unit 213 that accumulates electric charge by the electromagnetic induction, and a data transmitter unit 214 that transmits data.

The condenser unit 213 has a function of accumulating electric charge in response to the reception of the power pulses supplied from the receiver unit 20′ as the sending request and received through an antenna 22″. The data transmitter unit 214 has a function of transmitting data through the antenna 22″ with the energy accumulated in the condenser unit 213 used as a power supply.

The sending unit 20″ may be connected to a power supply. With such a configuration, the power pulses are used only as a reception signal and the condenser unit 213 may be omitted.

The transponder unit 20 integrates features and functions of the receiver unit 20′ and the sending unit (transmitter unit) 20″.

Operations of this embodiment are described with reference to a flow chart.

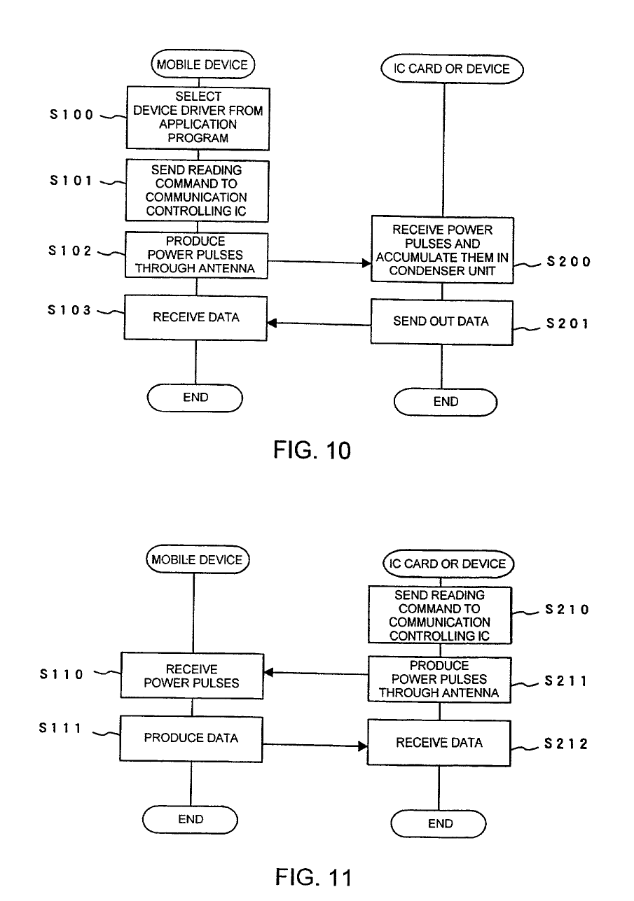

More specifically, receiving operations of the mobile device 10 are described with reference to the flow chart shown in FIG. 10, in conjunction with a case where data are received from an IC card or a device having an RFID interface.

First, the mobile device 10 is brought closer to the IC card or the device having the RFID interface. The range within which the IC card or the device having the RFID interface can communicate with the mobile device 10 depends on the type, i.e., the close-coupled type, the proximity type, the vicinity type. The close-coupled type, the proximity type, and the vicinity type are used for specific purposes. Data are transmitted and received using the device driver selected by the application program (S100). When a reading system call is called by the application program to the device driver, the device driver supplies a reading command to the communication controlling IC 21 (S101). The communication controlling IC 21 generates power pulses as the sending request through the antenna 22 (22′) via the read control unit 211 in response to the reception of the reading command.

The IC card or the device receives the power pulses as the sending request. The electric current generated by the electromagnetic induction is accumulated in the condenser unit 213 (S200). The power accumulated in the condenser unit 213 is used to send out data through the antenna 22″ (S201).

The mobile device 10 receives the data through the antenna 22 (22′) (S103). The data decoded by the data receiver unit 212 are passed from the device driver to the application program.

Sending operations of the mobile device 10 are described with reference to the flow chart shown in FIG. 11, in conjunction with a case where data are sent to an IC card or a device having an RFID interface.

In the IC card or the device, when the reading command is supplied to the communication controlling IC 21 (S210), the communication controlling IC 21 of the IC card or the device generates power pulses as the sending request through the antenna 22 (22′) via the read control unit 211 in response to the reception of the reading command (S211).

In response to the reception of the power pulses as the sending request (S110), the mobile device 10 uses them as an interrupting signal to the CPU to send out the data through the antenna 22 (22″) (S111). Alternatively, the electric current generated by the electromagnetic induction may be accumulated in the condenser unit 213 and the accumulated power in the condenser unit 213 may be used to send out the data.

The IC card or the device receives the data through the antenna 22 (22′) (S212).

While the description is made in conjunction with the case where the transponder unit of the mobile device 10 has the functions of the receiver unit and the sending unit (transmitter unit), the transponder unit may have either the function of the receiver unit or the function of the sending unit (transmitter unit).

The description is made for the electromagnetic induction, but a data receiving side may poll data as the sending request to receive the data.

The transponder unit 20 may be configured as a unit (such as a card-type unit) that can be loaded into and unloaded from the mobile device 10, on which different RFID interfaces may be mounted.

Alternatively, the recording element may be achieved by using something other than a semiconductor to achieve functions that are similar to those of the IC chip.

As described above, by using the mobile device 10 having the RFID interface, data can be exchanged with the IC card 50. Likewise, data can be exchanged with other device having the RFID interface.

It is possible to run an application program when the mobile device 10 reads specific data that are stored in the IC card 50 or the device. For example, the mobile device may connect to the Internet when it reads information in the IC card 50. Alternatively, instructions may be displayed when information is read out of a device containing an RFID interface.

In a second embodiment, an individual information system is described wherein the mobile device 10 integrates features of, for example, a commuter pass, a railway ticket, a credit card or a key (that are currently available by using an IC card). Described here is an example where features of cards, such as credit cards, are incorporated into the mobile device 10. The components and parts that are similar to those in the above-mentioned embodiment are denoted by like reference numerals, and detailed description thereof will be omitted.

Individual Information in Other Embodiments

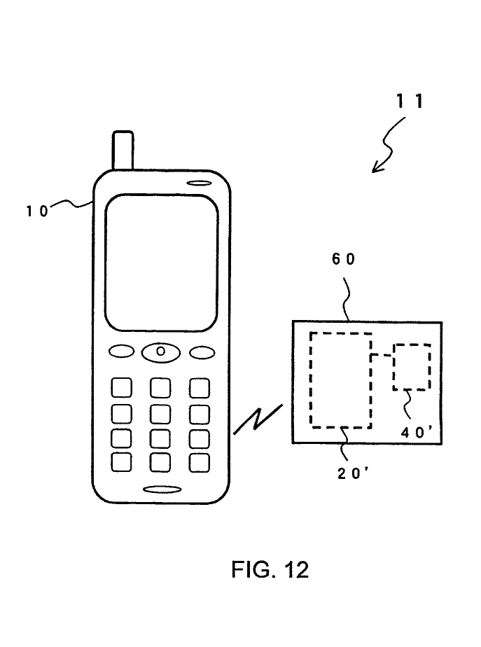

As shown in FIG. 12, a system 11 generally comprises the mobile device 10 and a receiver 60 in which the transponder unit 20′ (receiver unit) for the RFID interface is integrated.

The receiver 60 comprises the transponder unit 20′ and the control unit 40′ and has a function of reading individual information out of the mobile device 10. The mobile device 10 is brought closer to the receiver 60 to read the individual information. Therefore, it is preferable that the transponder unit 20′ used is the proximity type.

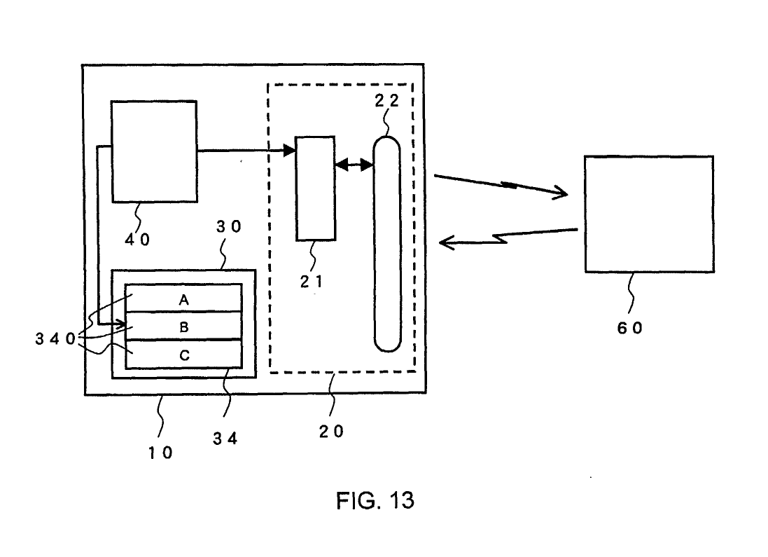

As shown in FIG. 13, in the mobile device 10, a piece of individual information 340 is stored in the data storage unit 34 on the memory 30. Described is an example where information associated with a card is stored as the individual information 340.

The individual information 340 may include a number of pieces of information corresponding to different cards (e.g., A, B, and C in FIG. 13). Among them, a card to be used can be selected. Two or more application programs 33 may be provided to achieve functions and features of the respective cards.

The following description is for the case where the individual information 340 is information associated with cards.

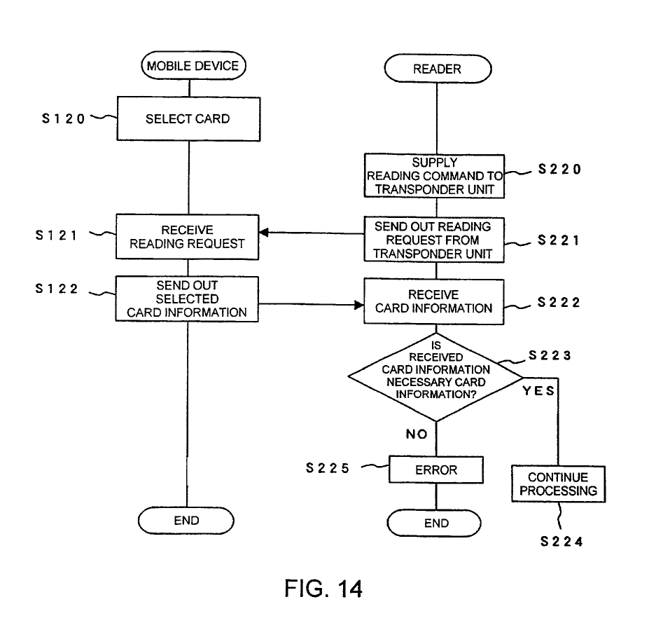

Operations of this embodiment are described with reference to the flow chart shown in FIG. 14.

A user selects a card to be used on the mobile device 10 (S120) and brings the mobile device 10 closer to the receiver 60. The receiver 60 supplies a reading command to the transponder unit 20 in response to the reception of an instruction to read card information 340 generated when, for example, the user depresses a reading switch on the receiver 60 (S220). It supplies a sending request (e.g., power pulses) to the mobile device 10, requesting the card information 340 (individual information) associated with the card that is designated by the transponder unit 20 (S221).

The mobile device 10 sends out the designated card information 340 in response to the reception of the sending request for the card information 340 (S122). The receiver 60 continues processing when the card information 340 that it receives coincides with the requested card information (S224). On the other hand, it is not the requested card information, then the operation is aborted and an error is returned (S225).

While the mobile device 10 in this embodiment integrates features of cards, it may have a feature or a function of a commuter pass or a railway ticket. In such a case, it is preferable that the transponder unit 20 of the receiver 60 is the proximity type in order to allow the transponder unit to read data out of a storage that is located slightly away from the transponder unit.

Alternatively, the mobile device 10 may have a feature or function of a key. In such a case, it is preferable that the transponder unit 20 of the receiver 60 is vicinity type or the proximity type in order to allow the transponder unit to read data out of a storage that is located rather away from the transponder unit.

The mobile device may have features or functions of electronic money, credit cards, membership cards, clinical records and tickets, health insurance cards, ID cards, or season tickets for entertainment facilities.

The individual information 340 may use identification information that identifies each mobile device 10.

When the mobile device 10 is replaced with another mobile device in buying a new one for example, such replacement is informed through, for example, the Internet to a management company where the information about the electronic money, credit cards, or membership cards stored in the mobile device 10 is managed. The information may then be disabled on the old mobile device 10 and may be downloaded to the new mobile device 10.

As described above, many features and functions can be combined on the mobile device 10.

In a third embodiment, a user identification system is described wherein a user of the mobile device 10 is identified using an IC chip in which the identification information is stored. The components and parts that are similar to those in the above-mentioned embodiments are denoted by like reference numerals, and detailed description thereof will be omitted.

An IC chip embedded in an object that the user can wear or have around is collectively referred to as a “red badge”.

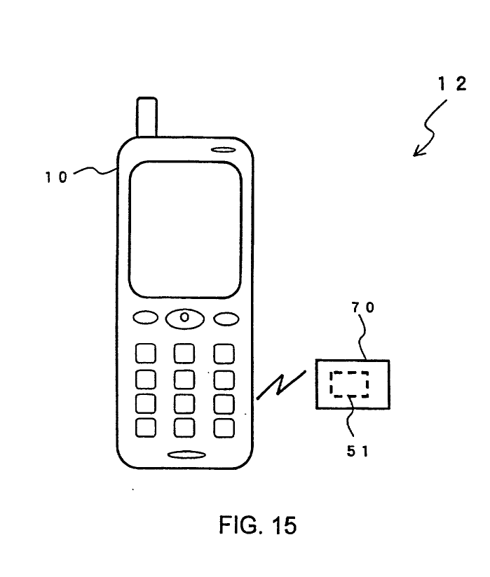

The user identification system 12 in the third embodiment generally comprises, as shown in FIG. 15, the mobile device 10 and a portable recording element in which the identification information is stored. The following description is for the case where the IC chip 51 and the antenna 22 are integrated with a red badge 70 as the portable recording element.

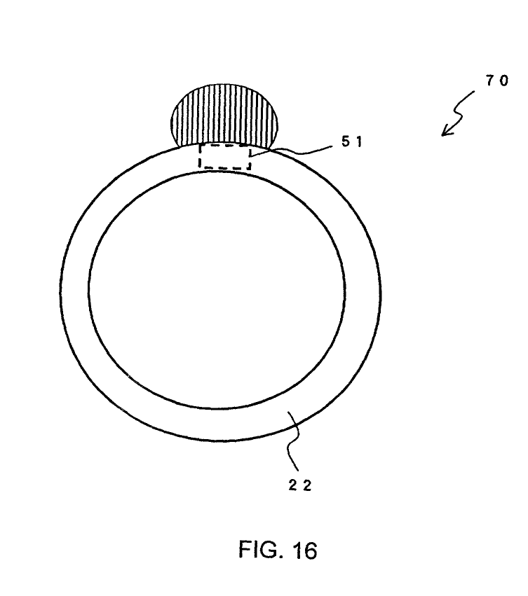

The red badge 70 described herein contains the IC chip 51. In the first mode of the red badge 70, an ordinary finger ring or earring is used as the antenna 22 where the IC chip 51 is provided as shown in FIG. 16.

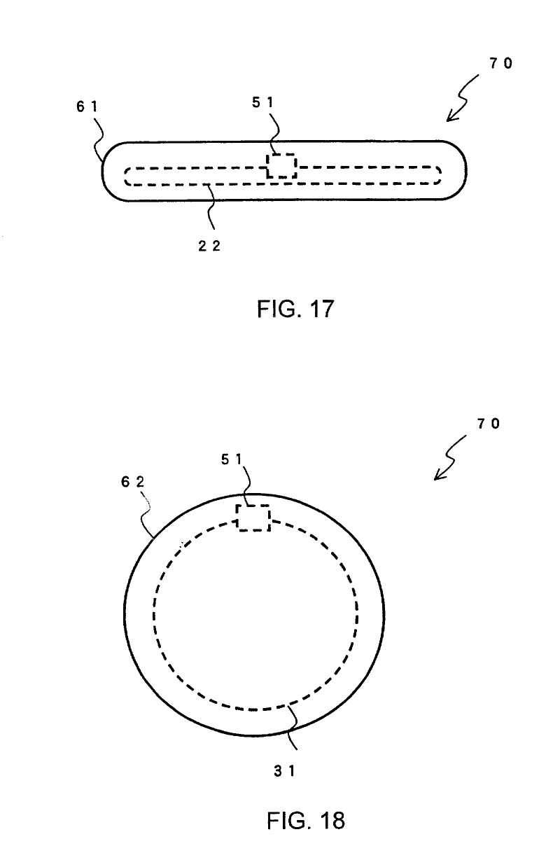

In the second mode, as shown in FIG. 17, the IC chip 51 and the antenna 22 may be embedded in a tie-pin 61. Alternatively, as shown in FIG. 18, the IC chip 51 and the antenna 22 may be embedded in a wearable product 62 such as a cuff button, a badge, a brooch, a pendant, or a contact lens.

Alternatively, the IC chip 51 and the antenna 22 may be embedded in a wallet, a purse, or a pass holder. The IC chip 51 and the antenna 22 may be embedded in a product that a user can have around, such as a writing instrument or a cigar lighter.

The above-mentioned examples are not intended to limit the present invention. The IC chip 51 may be embedded in or provided on various other products and things. The shape of the antenna 22 may be varied.

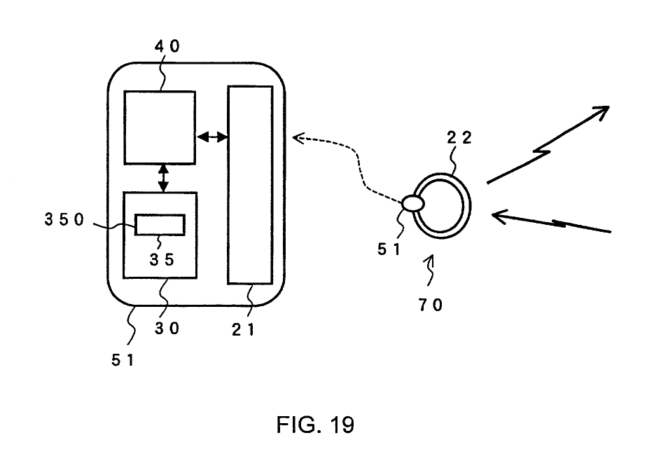

As shown in FIG. 19, the IC chip 51 in the red badge 70 causes the identification information to be stored in an identification information storing unit 35 on the memory 30. It is preferable that the identification information storing unit 35 is provided by using a non-rewritable recording element such as a ROM. An identification information 350 is allocated for a unique identification purpose. A unique identification information 350 may be written in each red badge 70 when during the production of the red badge.

Considering the case where two or more red badges of third parties are near the mobile device 10, it is preferable that the identification information 350 can be read only when the mobile device 10 is close to the red badge 70. The expression “close” means that the mobile device 10 can communicate with the red badge 70 that the user wears or so.

Taking the above-mentioned conditions into consideration, it is preferable to use an IC chip of the proximity type or the close-coupled type for the red badge 70. It is desired that red badge 70 and the mobile device 10 can communicate with each other only within a range of several tens of centimeters or smaller.

Next, operations of this embodiment are described with reference to a flow chart.

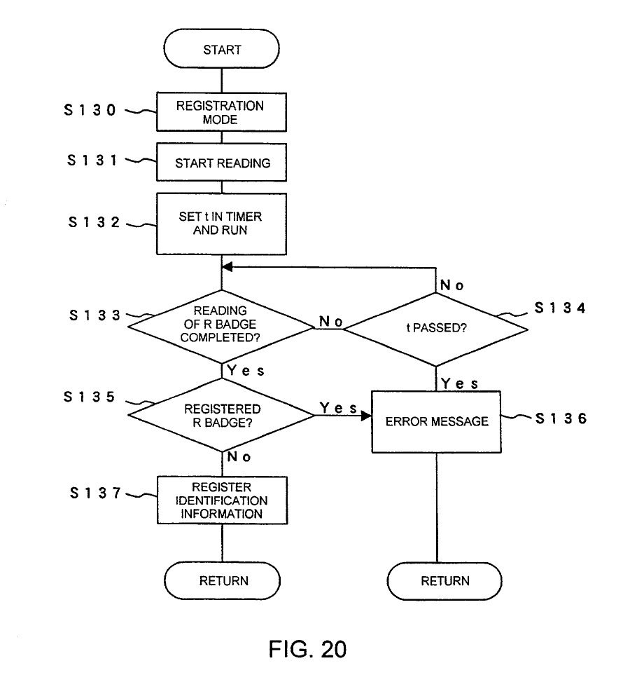

More specifically, operations to register the identification information 350 are described with reference to the flow chart shown in FIG. 20. In the following description, the red badge 70 is also referred to as an R badge.

A registration mode is selected to register the identification information 350 of the red badge 70 to the mobile device 10 (S130). The registration mode is available only when proper personal identification numbers or biometrics (e.g., iris scan biometrics, voice verification biometrics, fingerprint scan biometrics) are received, in order to avoid registration by a third party. In the registration mode, a start-reading command is supplied from the control unit 40 to the communication controlling IC 21. In response to this, a sending request (e.g., power pulses) is sent out through the antenna 22 to start to read information in the red badge 70 (S131).

A predetermined time interval t is set in a timer of the mobile device 10 (S132). It is repeatedly checked whether the identification information 350 is received from the red badge 70 (S133) until the time interval t elapses (S134).

When reception of the identification information 350 from the red badge 70 is not completed after the lapse of the time interval t, an error message is displayed on a display screen of the mobile device 10 (S135). On the other hand, when the received identification information is the identification information that is already registered, an error message is displayed on the display screen of the mobile device 10 (S135).

When the received identification information 350 is not the identification information that is already registered, the identification information 350 is stored in the memory 30 of the mobile device 10 for registration.

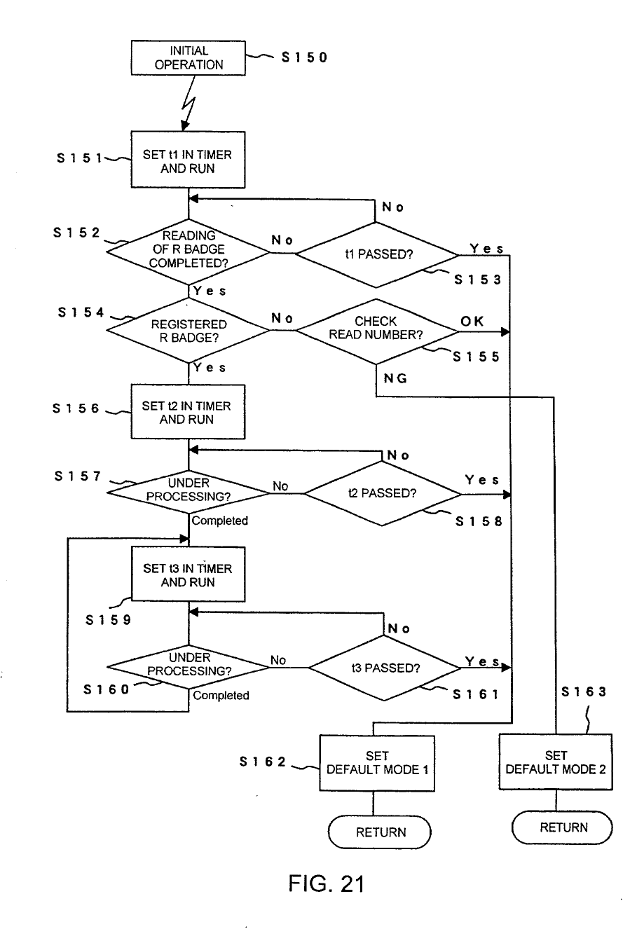

Operations to verify the identification information 350 of the red badge 70 near the mobile device 10 when the latter is used are described with reference to the flow chart shown in FIG. 21. A default mode 1 that is described with reference to the flow chart shown in FIG. 21 is released when the operation begins and the identification information 350 of the red badge 70 is read, which corresponds to the state where normal operation is not performed. On the other hand, release of a default mode 2 requires identification of the user based on, for example, personal identification numbers or biometrics, considering a possible mischief.

The user of the mobile device 10 performs an initial operation such as key input to use the mobile device 10. At the time of this initial operation, an interruption is supplied to the CPU of the control unit 40 (S150). In response to the interruption, a start-reading command is supplied from the control unit 40 to the communication controlling IC 21. The communication controlling IC 21 sends out a sending request through the antenna 22 to start to read, in response to the reception of the start-reading command.

The control unit 40 sets a predetermined time interval t1 in a timer (S151) and checks whether the identification information 350 supplied from the red badge 70 is received (S152). It repeatedly checks whether the identification information 350 is received, until the lapse of the time interval t1 (S153). When reception of the identification information 350 from the red badge 70 is not completed after the lapse of the time interval t1, the default mode 1 is set (S162).

On the other hand, when the reception of the identification information 350 is completed, the received identification information is compared with the identification information that is previously stored in the memory 30. When there is a match, it is determined that the registered red badge 70 is located close to the mobile device 10. Thus, the mobile device becomes available (S154). On the other hand, when there is no match, the red badge 70 in question is not the registered one. When the number of the unregistered identification information received is smaller than a predetermined number, the default mode 1 is set (S162). However, when the number of the unregistered identification information received is larger than the predetermined number, the default mode 2 is set (S163).

When the registered identification information is received (S154), a predetermined time interval t2 is set in the timer (S156). When no processing, such as making a phone call, receiving emails, or accessing the Internet, is performed (S207) before the lapse of the time interval t2 (S158), the default mode 1 is set (S162).

When the already-started processing, such as making a phone call, receiving emails, or accessing the Internet, is completed (S157) before the lapse of the time interval t2 (S158), a predetermined time interval t3 is set in the timer (S159). When subsequent processing, such as making a phone call, receiving emails, or accessing the Internet, is started (S160) before the lapse of the time interval t3 (S161), the user can continue the processing without reading the information on the red badge 70. The time interval t3 is activated each time when a single operation is finished (S159). When a subsequent operation is not started within t3 (S161), the default mode 1 is set (S162).

In the flow chart shown in FIG. 21, the identification information of the red badge 70 that is located near the mobile device is checked in response to the interruption generated as a result of an initial operation to use the mobile device 10. The processing corresponding to the user's operations is performed in parallel with the interruption processing.

In the default mode 2, the mobile device terminates its functions to perform a predetermined operation. For example, an alarm is issued by a beep or a ring tone at the maximum volume. Alternatively, a dial-locking may be used.

The default mode is set before shipment of the mobile device 10. However, users are allowed to choose and set operations for their specific applications. Users may modify the setting to ask a personal identification number each time when the mobile device 10 is used, depending on the security level.

The identification information 350 described above is received in response to the interruption during the operation. However, the mobile device 10 may poll to receive the identification information 350 from the red badge 70 to periodically check the presence or absence of the red badge 3.

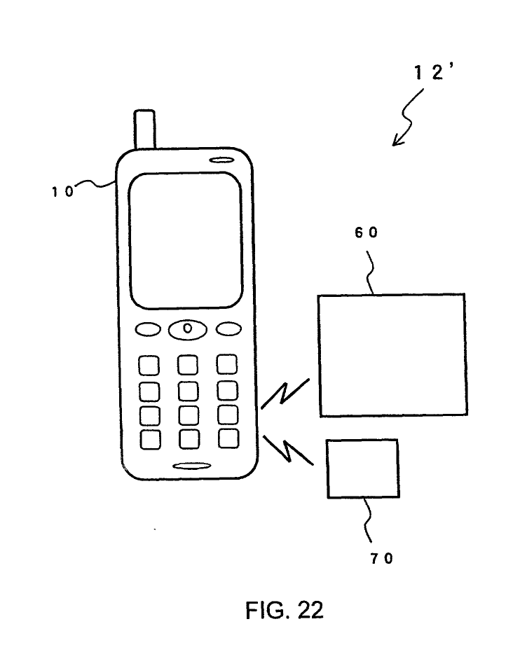

As in a user identification system 12′ shown in FIG. 22, the mobile device 10 may integrate features and functions of a commuter pass, a railway ticket, a credit card, or a key, as described in the second embodiment, and the features and functions may be received by the receiver 60. In such a case, the red badge 70 may be used to verify that the user of the mobile device 10 is a valid user.

As described above, the availability of the mobile device 10 can be controlled by means of checking the identification information of the portable receiving element that is incorporated in the red badge. This allows only the proper user to use the device.

In a fourth embodiment, a function of writing data in the recording element such as the IC chip in the mobile device 10 is described. The components and parts that are similar to those in the above-mentioned embodiments are denoted by like reference numerals, and detailed description thereof will be omitted.

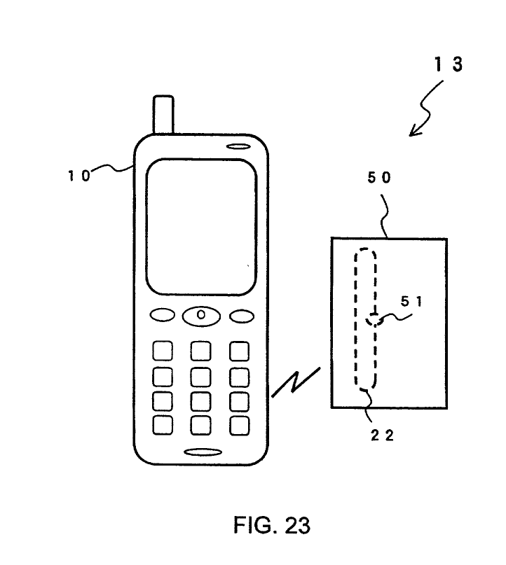

A carriable recording element write-in system 13 in the fourth embodiment generally comprises, as shown in FIG. 23, the mobile device 10 and the IC card 50 in which the recording element 51 and the antenna 22 are embedded. An example is described for the case where data is written in the IC card 50 in which the recording element 51 and the antenna 22 are embedded.

The recording element 51 has the identification information 350 stored therein.

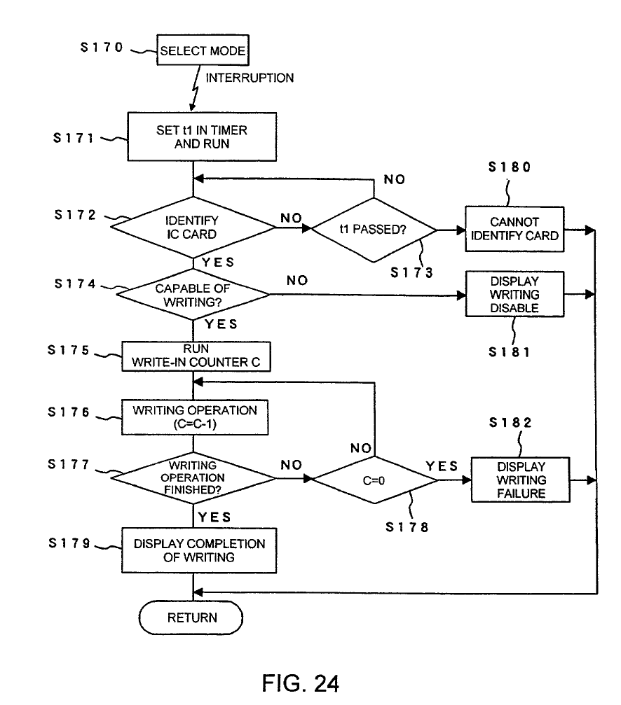

Operations of this embodiment are described with reference to the flow chart shown in FIG. 24.

The user of the mobile device 10 selects a writing mode. At the time of this selection, an interruption is supplied to the CPU of the control unit 40 (S170). In response to the interruption, a start-reading command is supplied from the control unit 40 to the communication controlling IC 21. The communication controlling IC 21 sends out a reading request (e.g., power pulses) through the antenna 22 in response to the reception of the start-reading command to start to read the registered identification information 350 to the IC card 50.

The control unit 40 of the mobile device 10 sets a predetermined time interval t1 in a timer (S171). It checks whether the identification information 350 is received from the IC card 50 (S172). The reception of the identification information 350 is repeatedly checked until the time interval t1 elapses (S173). When the reception of the identification information 350 from the IC card 50 is not completed after the lapse of the time interval t1, then a message indicating that the card cannot be identified is displayed (S180).

When the reception of the identification information 350 is completed, the received identification information is compared with the identification information that is previously registered in the memory 30. When there is a match (S174), it is determined that the IC card is the registered IC card 50. On the other hand, when there is no match (S174), the IC card is not the registered IC card 50. Therefore, a message indicating that nothing can be written in is displayed (S181).

For the registered IC card 50, a write-in counter C is set (S175). Then, writing operation (S176) is carried out. When the writing operation is not finished correctly (S177), the writing operation is again performed (S176) until the write-in counter C is indicates 0 (S178). When nothing can be written even after the write-in counter C indicates 0, a message indicating a writing failure is displayed (S182).

When the writing operation is finished without any problem, completion of the writing is displayed (S179).

As described above, in the mobile device 10 with the RFID interface, digital information such as received digital tickets can be written into the IC card 50. Further, the cashing service may be used through the Internet by using the mobile device 10 and the amount of the credits may be written into the IC card 50.

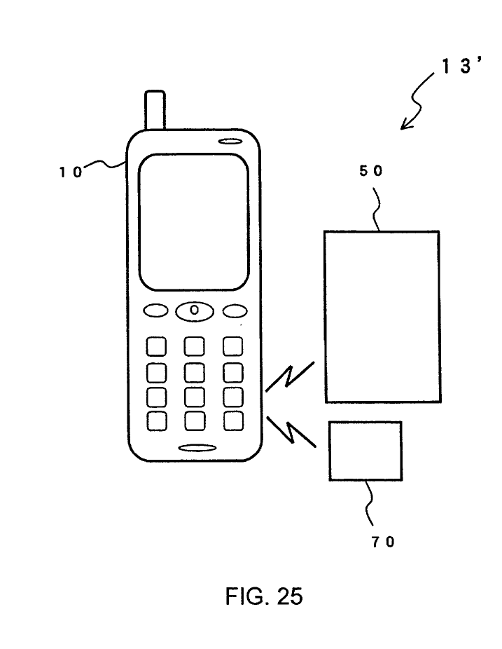

As in a carriable recording element write-in system 13′ shown in FIG. 25, the red badge 70 may be used to verify that the user of the mobile device 10 is a valid user in writing data in the IC card 50.

This allows only the proper customer of the mobile device 10 to write data in the IC card 50.

In a fifth embodiment, a first log management system is described wherein log histories of the mobile device 10 and the IC card 50 are managed through a line such as the Internet. The components and parts that are similar to those in the above-mentioned embodiments are denoted by like reference numerals, and detailed description thereof will be omitted.

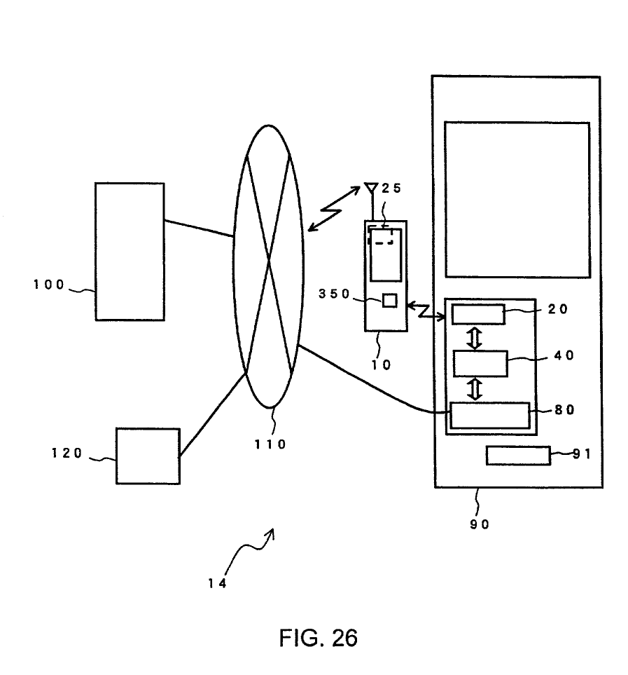

A log management system 14 in the fifth embodiment comprises, as shown in FIG. 26, the mobile device 10, a device 90 in which the recording element such as the IC card 50 and the transponder unit of the RFID interface are incorporated, and management server 100, which are connected to each other via a communication line 110. The communication line 110 may be connected to banking facilities 120 such as bank terminals or net banks.

Each of the mobile device 10 and the recording element such as the IC card 50 stores non-rewritably the identification information 350 to identify them uniquely. The mobile device 10 comprises the transponder unit 20 of the RFID interface. It has a function to send out the identification information 350. The mobile device 10 comprises a communication line transmitter unit 25. It has a function of connecting to the Internet or other networks via a communication line.

In this specification, the device 90 is exemplified as a vending machine in which the transponder unit of the RFID interface is incorporated. The device 90 can communicate with the mobile device 10 having the RFID interface and the IC card 50. The device has a function of collecting costs by deducting the amount from a prepaid card or a cash card that is recorded on the mobile device 10 or the IC card 50.

The device 90 also comprises a server connection unit 80 that communicates with the management server 100 through the communication line 110. Further, the device 90 has a device number 91 that is allocated to each device.

The management server 100 comprises a management unit that receives the identification information 350 of the mobile device 10 and the IC card 50 along with the log information thereof through the communication line 110 and manages log information indicating the details about the log histories.

The communication line 110 may be a leased line or the Internet. It is preferable that the communication line is a secure one from the reliability concern for the information management.

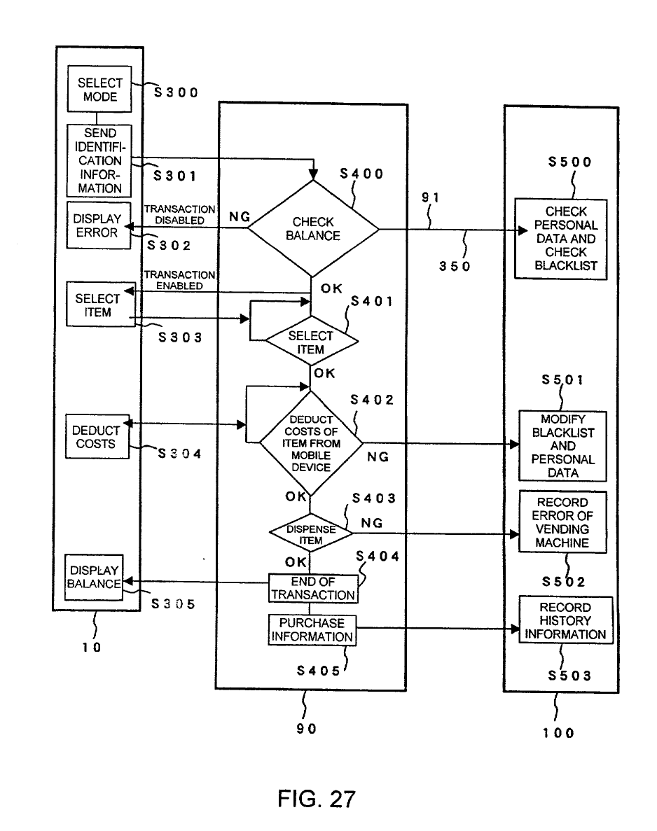

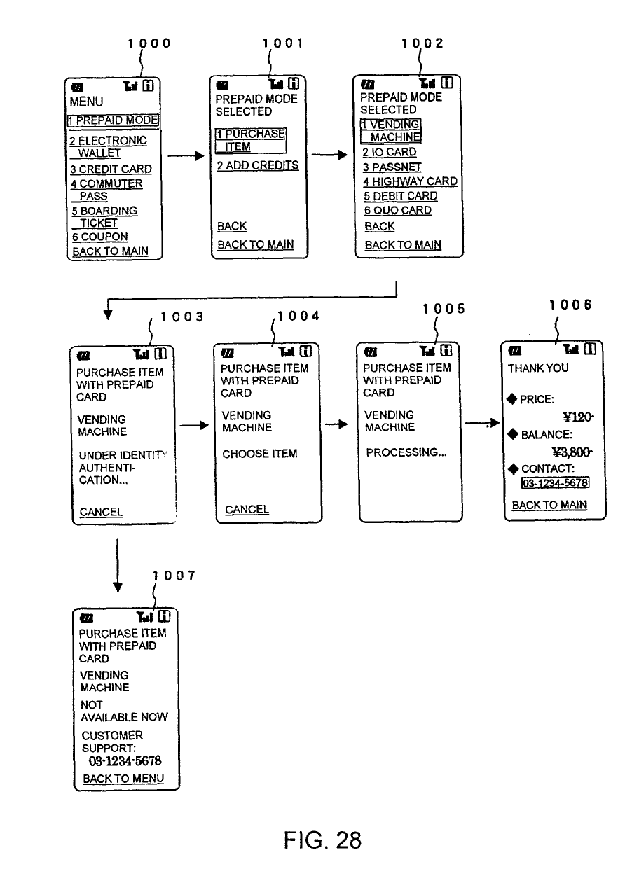

Operations of this embodiment are described for the mobile device 10 with reference to the flow chart shown in FIG. 27 and the details on the display screen of the mobile device 10 shown in FIG. 28.

In the mobile device 10, a user chooses a prepaid card mode 1000 from a menu and then shifts to a purchasing mode 1001 and to a vending machine mode 1002 (S300), as shown in the details on the display screen in FIG. 28. At this time, the identification information 350 is supplied from the RFID interface of the mobile device 10 to the vending machine 90. In response to this, a display screen 1003 indicating that the vending machine is under identity authentication is displayed on the mobile device 10 (S301). The vending machine 90 and the mobile device 10 communicate with each other through the RFID interfaces.

The vending machine 90 supplies the identification information 350 of the mobile device 10 and the device number 91 of the vending machine 90 to the management server 100 by the server connection unit 80 in response to the reception of the identification information 350. Thus, the vending machine checks the remaining credits and compares the received information with a blacklist (S400). The management server 100 checks personal data of the owner of the mobile device 10 based on the identification number 350. Then, it checks out the blacklist (S500).

Alternatively, a blacklist may be supplied to and stored in the vending machine 90. The vending machine 90 may then check out the blacklist. This reduces the time required for the communication with the management server 100, enhancing the convenience.

In the following description, the vending machine 90 and the management server 100 communicate with each other through the server connection unit 80.

In the vending machine 90, when the result of the check obtained by the management server 100 indicates that there is a problem in the personal data or the blacklist (S400), the vending machine supplies a message to the mobile device 10 indicating that transaction is not disabled. The mobile device 10 displays a display screen 1007 indicating that the vending machine is not available (S302).

When there is no problem in the personal data and the blacklist (S400), the vending machine supplies a message indicating that the transaction is enabled to the mobile device 10. The mobile device 10 displays a display screen 1004 to allow the user to choose an item (S303).

When an item is selected on the vending machine 90 (S401), debit data for the costs, or price, of the item(s) are supplied from the vending machine 90 to the mobile device 10 (S402). In the mobile device 10, the costs are deducted and a processing display screen 1005 is displayed (S304). When the costs cannot be deducted correctly from the mobile device 10 (S402), a “no good” indication is supplied as the log information from the vending machine 90 to the management server 100. Then, the personal data or the blacklist is updated (S501).

When the costs are deducted without any problem from the mobile device 10 (S402) but the item is not dispensed correctly (S403) in the vending machine 90, a “no good” indication is supplied as the log information from the vending machine 90 to the management server 100. The device number 91 of the troubled vending machine 90 is recorded (S502).

When the costs are deducted from the mobile device 10 (S402) and the item is dispensed without any problem (S403), the end of transaction is notified from the vending machine 90 to the mobile device 10. The mobile device 10 displays the remaining credits, or the balance, on a display screen 1006 (S305). Purchase information is supplied from the vending machine 90 to the management server 100 as the log information and is recorded as a history (S503).

While the description is made for the mobile device 10, similar operations can be applied to the IC card 50.

When an item is not dispensed correctly from the vending machine 90, the costs may be refunded when the user connects to the management server 100 using the communication line transmitter unit 25 of the mobile device 10 through the communication line 110 and identifies which vending machine 90 he or she used, based on the device number 91, from the identification number 350 of the mobile device 10 and the log information associated with the vending machine 90.

It is also possible to receive the device number 91 of the vending machine 90 through the transponder unit 20 of the RFID interface of the mobile device 10, and to send the log information, the identification information 350 of the mobile device 10, and the device number 91, from the communication line transmitter unit 25 of the mobile device 10 to the management server 100 through the communication line 110.

The description is made for the case where the mobile device 10 is used as a prepaid card. However, similar operations can be applied when the mobile device 10 is used as a cash card, a debit card, a reward card, a smart card, or a credit card.

It is preferable by the security considerations that the information is encrypted before sent out to the management server.

As described above, it is possible to keep the log histories of the mobile device 10 by managing combinations of the identification information 350 uniquely allocated to the mobile device 10 and the log information.

The mobile device 10 may exploit features of the global positioning system (GPS). With such a configuration, a highly accurate position of the mobile device 10 can be obtained by means of the position information. The information may be compared with the device number 91 to prevent illegal use of the device.

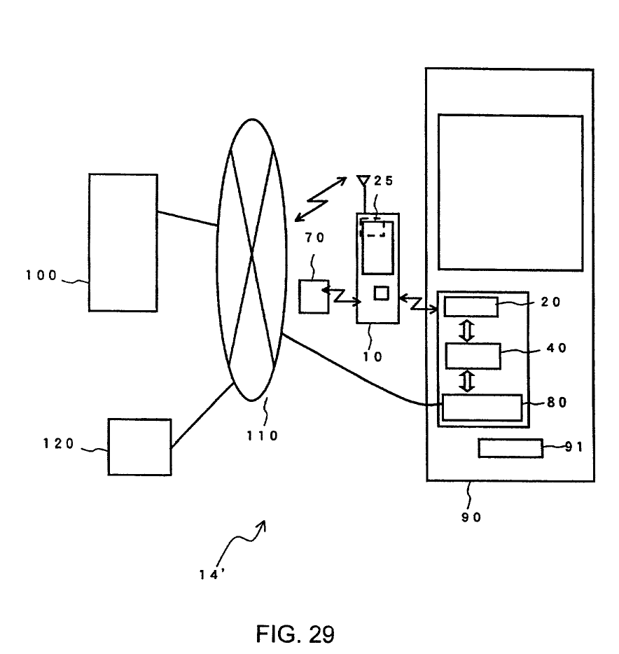

In addition, the mobile device 10 may be used as in a log management system 14′ shown in FIG. 29. In such a case, the red badge 70 may be used to verify that the user of the mobile device 10 is a valid user as described in the third embodiment.

This allows only the proper customer of the mobile device 10 to use the mobile device 10.

In a sixth embodiment, a second log management system is described wherein features of a cash card or a prepaid card are registered to the mobile device 10 or the IC card 50 using a line such as the Internet. The components and parts that are similar to those in the above-mentioned embodiments are denoted by like reference numerals, and detailed description thereof will be omitted.

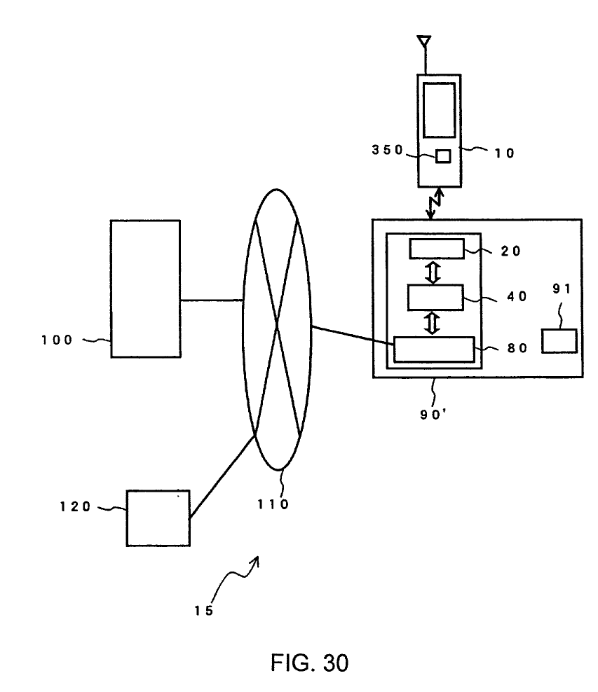

A log management system 15 in the sixth embodiment comprises, as shown in FIG. 30, the mobile device 10, a device 90′ in which the IC card 50 and the transponder unit 20 of the RFID interface are incorporated, and management server 100, which are connected to each other via a communication line 110. The communication line 110 is connected to banking facilities 120 such as bank terminals or net banks.

The device 90′ herein is a prepaid vending machine 90′ having the transponder unit 20 of the RFID interface. The remaining credits, or the balance, of a prepaid card recorded on the mobile device 10 or the IC card 50 is updated. The device 90′ has a device number 91 that is allocated to each device.

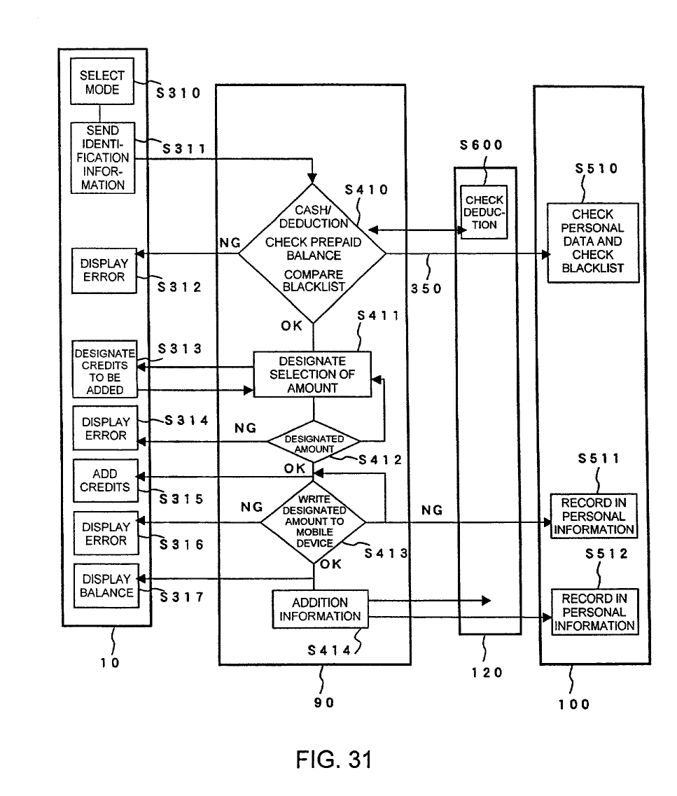

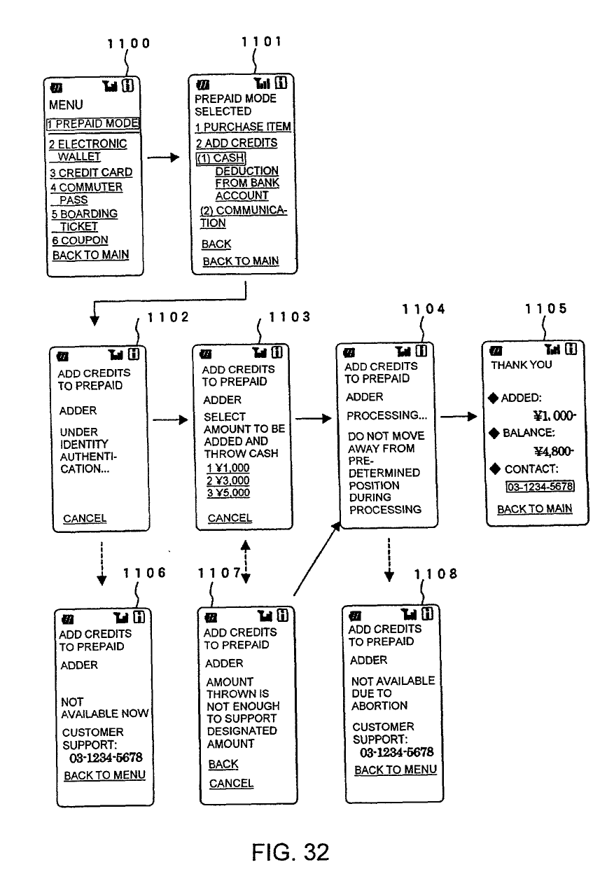

Operations of this embodiment are described with reference to the flow chart shown in FIG. 31 and the details on the display screen of the mobile device 10 shown in FIG. 32.

In the mobile device 10, a user chooses a prepaid card mode 1100 from a menu and then shifts to a credit addition mode 1101 (S310), as shown in the details on the display screen in FIG. 32. At this time, the identification information 350 is supplied from the mobile device 10 to the prepaid vending machine 90′ through the RFID interface. In response to this, a display screen 1102 indicating that the vending machine is under identity authentication is displayed on the mobile device 10 (S311).

The prepaid vending machine 90′ supplies the identification information 350 of the mobile device 10 to the management server 100 by the server connection unit 80 in response to the reception of the identification information 350. Thus, the vending machine checks the remaining credits and compares the received information with a blacklist (S410). The management server 100 checks personal data of the owner of the mobile device 10 based on the identification number 350. Then, it checks out the blacklist (S510). In the following description, the prepaid vending machine 90′ and the management server 100 communicate with each other through the server connection unit 80.

In the prepaid vending machine 90′, when there is a problem in the personal data or the blacklist (S410), the vending machine supplies a message to the mobile device 10 indicating that no credit can be added. The mobile device 10 displays a display screen 1106 indicating that the credit cannot be added (S312).

When there is no problem in the personal data and the blacklist (S410), the vending machine supplies a message indicating that the transaction is enabled to the mobile device 10. The mobile device 10 displays a display screen 1103 to allow the user to choose the amount to be added (S313). In the prepaid vending machine 90′, when the amount to be added is determined (S411), the data corresponding to that amount are supplied to the mobile device 10 (S412).

It is checked that a bank account balance in a banking facility 120 is big enough to support the designated amount (S412). If it is not, a message indicating insufficient funds is supplied to the mobile device 10 to display an error display screen 1107 indicating the insufficient funds (S314). When the bank account balance is big enough, the amount is added and a processing display screen 1104 is displayed (S315). When the addition cannot be made correctly from the mobile device 10 (S413), a “no good” indication is supplied as the log information to the management server 100. Then, an error is recorded on the personal data (S511). The mobile device 10 displays an error display screen 1008 indicating that addition is aborted (S316).

When the addition is performed without any problem from the mobile device 10 (S413), the balance is displayed on the display screen 1108 of the mobile device 10 (S317). Addition information and the device number 91 of the prepaid vending machine 90′ are supplied to the management server 100 as the log information and are recorded as a history (S512).

The above-mentioned description is for the case where the credits are added to the mobile device 10 by means of deducting the corresponding amount from the bank account balance in a banking facility 120 such as a bank. However, cash may be thrown into the prepaid vending machine 90′ to add the credits to the mobile device 10.

The vending machine 90 may be used as the prepaid card vending machine 90′.

The description is made for the case where the mobile device 10 is used as a prepaid card. However, similar operations can be applied when the mobile device is used as a cash card, a debit card, a credit card, a membership card, clinical records and tickets, a health insurance card, an ID card, or a season ticket for entertainment facilities.

In this embodiment, the purpose-oriented machine 90′ having the RFID interface is used as an example. However, the amount may be deducted directly from a bank account in a banking facility 120 through the communication line 110 to add the credits to the mobile device 10. The identification information 350 of the mobile device 10 and the log information may be supplied to the management server 100.

Interconnection with credit card companies through the communication line 110 may be used to add features of a credit card to the mobile device 10.

As described above, it is possible to combine the mobile device 10 with features of, for example, different cards. All log histories stored in the mobile device 10 can be managed by using the identification number 350.

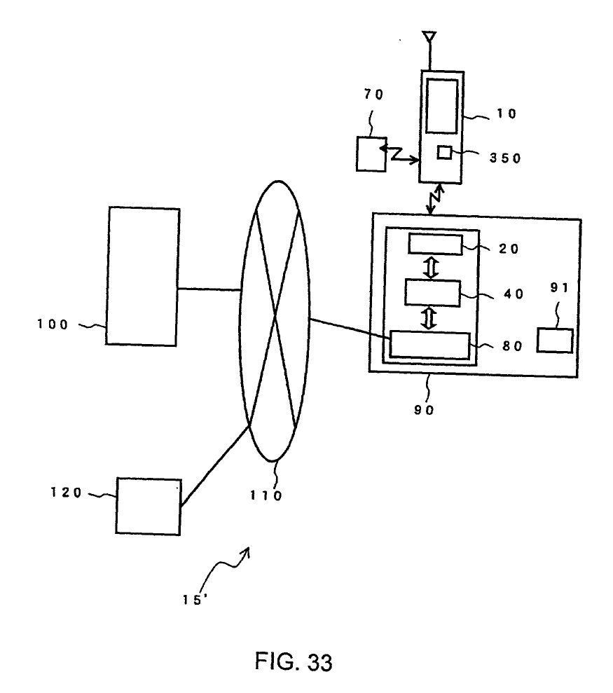

In addition, credits may be added to the mobile device 10 as in a log management system 15′ shown in FIG. 33. In such a case, the red badge 70 may be used to verify that the user of the mobile device 10 is a valid user as described in the third embodiment.

This allows only the proper customer of the mobile device 10 to add credits to the mobile device 10.

In a seventh embodiment, communication between the mobile devices 10 each having the RFID interface is described. The components and parts that are similar to those in the above-mentioned embodiments are denoted by like reference numerals, and detailed description thereof will be omitted.

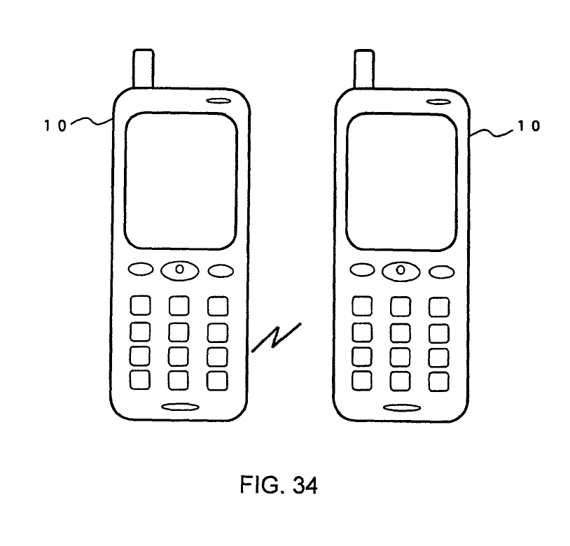

As shown in FIG. 34, it is possible to perform communication using RFID interface when the mobile device 10 is close to another mobile device 10. With this configuration, digital information may be transferred to a receiving mobile device 10, such as digital money, “chaku mero” indicating cellular phone ring melodies or programs to get various melodies, or “machiuke gamen” indicating a standby screen that shows by default when no other activity is going on.

As described above, according to the present invention, sensitive personal information can be registered on a mobile device, such as the one associated with commuter passes, credit cards, driver's licenses.

Log histories of a mobile device can be obtained positively and reliably based on identification information that is uniquely allocated to each mobile device. This prevents abuse of the device.

Even in case where the mobile device is passed into a malicious third party's possession, he or she cannot use the device for the wrong purposes unless he or she obtain the corresponding red badge (IC chip).

This prevents the owner from paying for something that he or she didn't buy.

Alternatively, leakage of the personal data on the mobile device can be avoided.

The mobile device can communicate with a contactless IC chip. This means that the IC card can be identified from the mobile device. Re-writing can be made to provide an RFID system easily.

1. An information protection system comprising a first assembly in which protected information is stored, and a second assembly in which authentication data are stored, wherein
said second assembly comprises communication means that allows said second assembly to send information contactlessly in response to a request from said first assembly, and
said first assembly comprises:
receiving means for receiving access to the protected information;
authentication means for performing authentication in response to the reception of the authentication data from said second assembly; and
access control means that enables or disables the access received by said receiving means, depending on the result of the authentication obtained by said authentication means.

2. An information protection system comprising a first assembly and a second assembly, the first assembly having information for authentication and protected information stored therein, wherein
said first assembly and said second assembly comprises respective communication means that allow said first assembly and said second assembly to exchange information contactlessly with said second assembly and said first assembly, respectively,
said second assembly further comprising authentication means for performing authentication in response to the reception of the authentication data from said first assembly,
said first assembly further comprising:
receiving means for receiving access to the protected information; and
access control means that receives the result of the authentication obtained by said authentication means, from said second assembly, and enables or disables the access received by said receiving means, depending on the result of the authentication.

3. An information protection system comprising a first assembly in which first authentication data and protected information are stored, the first authentication data being to be used for authenticating an owner thereof, and a second assembly in which second authentication data are stored, the second authentication data being to be used for authenticating the owner, wherein
said first assembly and said second assembly comprises respective communication means that allow said first assembly and said second assembly to exchange information contactlessly with said second assembly and said first assembly, respectively,
said second assembly further comprising second authentication means for performing, in response to the reception of the first authentication data from said first assembly, authentication based on the received first authentication data and the second authentication data,
said first assembly further comprising:
receiving means for receiving access to the protected information;
first authentication means for performing, in response to the reception of the second authentication data from said second assembly, authentication based on the received second authentication data and the first authentication data; and
access control means that enables or disables the access received by said receiving means, depending on the result of the authentication obtained by said first authentication means and the result of the authentication obtained by said second authentication means and received from said second assembly.

4. The information protection system as claimed in claim 1, wherein said first assembly and said second assembly are each independently portable or contained in a portable product.

5. The information protection system as claimed in claim 2, wherein said first assembly and said second assembly are each independently portable or contained in a portable product.

6. The information protection system as claimed in claim 3, wherein said first assembly and said second assembly are each independently portable or contained in a portable product.

7. The information protection system as claimed in claim 1, wherein said communication means carries out wireless communications by electromagnetic induction, wireless communications by electromagnetic coupling, wireless communications by electrostatic coupling, or communications that use frequencies in the microwave region.

8. The information protection system as claimed in claim 1, wherein the protected information is information of a personal nature and/or information of a proprietary nature.

9. The information protection system as claimed in claim 1, wherein said first assembly and said second assembly are each an IC module including an antenna for contactless communications.

10. The information protection system as claimed in claim 1, wherein said first assembly is embedded in a card-like material.

11. The information protection system as claimed in claim 1, wherein said first assembly is embedded in a sheet-like material.

12. The information protection system as claimed in claim 1, wherein said first assembly is contained in a portable device.

13. The information protection system as claimed in claim 1, wherein said first assembly is contained in a data carrier.

14. The information protection system as claimed in claim 1, wherein said second assembly is what the owner of said first assembly always carries around.

15. An information protection system comprising a first assembly in which first authentication data and protected information are stored, the first authentication data being to be used for authenticating an owner thereof, a second assembly in which second authentication data are stored, the second authentication data being to be used for authenticating the owner, and an information reader for reading the protected information, wherein
said first assembly comprises first communication means that allows said first assembly to exchange information contactlessly with said second assembly and said information reader,
said second assembly comprises second communication means that allows said second assembly to exchange information contactlessly with said first assembly, and
said information reader comprises third communication means that allows said information reader to exchange information contactlessly with said first assembly,
said first assembly further comprising means for receiving the second authentication data from said second assembly in response to a signal from said information reader and performing authentication based on the received second authentication data and the first authentication data, thereby to permit or prohibit reading of the protected information by said information reader, depending on the result of the authentication.

16. An information protection system comprising a first assembly in which first authentication data and protected information are stored, the first authentication data being to be used for authenticating an owner thereof, a second assembly in which second authentication data are stored, the second authentication data being to be used for authenticating the owner, and an information reader for reading the protected information, wherein
said first assembly comprises first communication means that allows said first assembly to exchange information contactlessly with said second assembly and said information reader,
said second assembly comprises second communication means that allows said second assembly to exchange information contactlessly with said first assembly, and
said information reader comprises third communication means that allows said information reader to exchange information contactlessly with said first assembly,
said second assembly further comprising means for receiving the first authentication data from said first assembly, performing authentication based on the received first authentication data and the second authentication data, and sending the result of the authentication to said first assembly,
said first assembly further comprising means for sending the first authentication data to said second assembly in response to a signal from said information reader, and receiving the result of the authentication from said second assembly, thereby to permit or prohibit reading of the protected information by said information reader, depending on the received result of the authentication.

17. An information protection system comprising a first assembly in which first authentication data and protected information are stored, the first authentication data being to be used for authenticating an owner thereof, a second assembly in which second authentication data are stored, the second authentication data being to be used for authenticating the owner, and an information reader for reading the protected information, wherein
said first assembly comprises first communication means that allows said first assembly to exchange information contactlessly with said second assembly and said information reader,
said second assembly comprises second communication means that allows said second assembly to exchange information contactlessly with said first assembly, and
said information reader comprises third communication means that allows said information reader to exchange information contactlessly with said first assembly,
said second assembly further comprising second authentication means for receiving the first authentication data from said first assembly, performing second authentication based on the received first authentication data and the second authentication data, and sending the result of the authentication to said first assembly,
said first assembly further comprising:
first authentication means for sending the first authentication data to said second assembly in response to a signal from said information reader, receiving the second authentication data from said second assembly, and performing first authentication based on the received second authentication data and the first authentication data; and means that permits or prohibits reading of the protected information by said information reader, depending on the result of the authentication obtained by said first authentication means and the result of the authentication obtained by said second authentication means and received from said second assembly.

18. The information protection system as claimed in claim 15, wherein said first assembly and said second assembly are each independently portable or contained in a portable product.

19. The information protection system as claimed in claim 16, wherein said first assembly and said second assembly are each independently portable or contained in a portable product.

20. The information protection system as claimed in claim 17, wherein said first assembly and said second assembly are each independently portable or contained in a portable product.

21. The information protection system as claimed in claim 15, wherein said first through third communication means each carries out wireless communications by electromagnetic induction, wireless communications by electromagnetic coupling, wireless communications by electrostatic coupling, or communications that use frequencies in the microwave region.

22. The information protection system as claimed in claim 15, wherein the protected information is information of a personal nature and/or information of a proprietary nature.

23. The information protection system as claimed in claim 15, wherein said first assembly and said second assembly are each an IC module including an antenna for contactless communications.

24. The information protection system as claimed in claim 15, wherein said first assembly is embedded in a card-like material.

25. The information protection system as claimed in claim 15, wherein said first assembly is embedded in a sheet-like material.

26. The information protection system as claimed in claim 15, wherein said first assembly is contained in a portable device.

27. The information protection system as claimed in claim 15, wherein said second assembly is what the owner of said first assembly always carries around.

28. An information protection method comprising providing first and second assemblies independently at different locations, the first and second assemblies being capable of exchanging information contactlessly with each other, and storing protected information on the first assembly, wherein
the first assembly accepts an access request to the protected information, provided that the second assembly is within an area that can communicate contactlessly with the first assembly at the time when the access request is issued.

29. The method as claimed in claim 28, wherein the first assembly and the second assembly are each independently contained in a portable product.

30. The method as claimed in claim 28, wherein authentication data are stored in at least one of the first assembly and the second assembly, the authentication data being to be used to uniquely identify a holder of the first assembly, and the first assembly accepts the access request only when the holder is identified as a result of the authentication performed on the basis of the authentication data.

31. The information protection system as claimed in claim 1, wherein said access control means enables the access to the protected information until a predetermined time period has elapsed from the reception of the access request, when the result of the authentication obtained by said authentication means indicates permission of the access.

32. The information protection system as claimed in claim 15, wherein said access control means enables the access to the protected information until a predetermined time period has elapsed from the reception of the access request, when the result of the authentication obtained by said authentication means indicates permission of the access.
